(19) United States
(12) Patent Application Publication
(10) Pub. No.: US 2007/0135956 A1
(43) Pub. Date: Jun. 14, 2007

(54) Data location systems and methods

(75) Inventors: Shi-Chieh Liao, Toufen (TW); Shui-Tien Lin, Hsinchu City (TW); Chen-Ting Lin, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/301,520

(22) Filed: Dec. 13, 2005

(51) Int. Cl. G06F 19/00

(52) U.S. Cl. 700/108

(57) ABSTRACT

Data location methods are implemented in an information provider storing and providing engineering data sets of fabrication. The information provider is coupled to a network. A first operation is received through the network. A portion of the engineering data sets is provided through the network in response to the first operation. Direction to the next operation operable on the information provider is automatically provided according to characteristics of the portion of the engineering data sets.

### BACKGROUND

The invention relates to data management, and in particular, to location elements in stored data sets.

Engineering data sets in semiconductor manufacturing reflect information of semiconductor products, equipment, and facilities, and various stages of manufacturing processes, such as etching, doping, ion implantation, packaging, and testing. Since engineering data sets play an important role in assisting customers to prevent fabrication delay and technical errors, customers increasingly use engineering data sets, such as data sets of wafer acceptance tests (WAT), chip probing (CP), inline test, and others.

As types of engineering data sets provided by an information system grow, use of engineering data sets and retrieval of desired data therefrom becomes more and more difficult and time consuming. For example, correlation between CP and inline data sets may technically involve other engineering data sets, characteristic values thereof, or correlations therebetween. Newer customers, however, may be unschooled in the information system. Additionally, data actually involved may vary from case to case. No effective method is presented to deal with this issue.

### SUMMARY

Accordingly, data location methods and systems are provided.

An exemplary embodiment of a data location method is implemented in an information provider storing and providing engineering data sets of semiconductor fabrication. The information provider is coupled to a network, through which, when first operation is received, a portion of the engineering data sets is provided in response. Direction to the next operation operable on the information provider is automatically provided according to characteristics of the portion of the engineering data sets.

An exemplary embodiment of a data location system comprises a first storage unit, an interface module, and a guide coupled to the first storage unit and the interface module. The first storage unit coupled to a network stores data sets of semiconductor fabrication. The interface module coupled to the first storage unit receives a first operation and provides a portion of corresponding engineering data sets. The guide automatically provides corresponding direction to a next operation operable on the interface module.

An exemplary embodiment of a data location system comprises a first storage unit, an interface module, a third storage unit, and a learning module. The first storage unit coupled to a network stores engineering data sets of semiconductor fabrication. The interface module coupled to the first storage unit receives a first operation, provides a portion of the engineering data sets, and subsequently receives a second operation through the network. The third storage unit coupled to the interface module stores a history of operations performed on the interface module. The learning module coupled to the interface module and the third storage unit stores the first operation and the second operation in the third storage unit and associates the second operation with the characteristics of the portion of the engineering data sets.

### DESCRIPTION OF THE DRAWINGS

The invention can be more fully understood by reading the subsequent detailed description and examples with references made to the accompanying drawings, wherein:

FIG. 1 is a block diagram of an exemplary embodiment of a semiconductor foundry and customers.

FIG. 2 is a block diagram of an exemplary embodiment of an information provider.

FIG. 3 is an exemplary embodiment of rules for operation direction.

FIG. 4 is a schematic diagram of an exemplary operation history of the information provider.

FIG. 5 is a block diagram of another exemplary embodiment of an information provider.

FIG. 6 is a flowchart of an exemplary embodiment of a data location method.

FIG. 7 is a schematic diagram of an exemplary embodiment of direction.

FIG. 8 is a schematic diagram of another exemplary embodiment of direction.

### DETAILED DESCRIPTION

Data location systems and methods are provided.

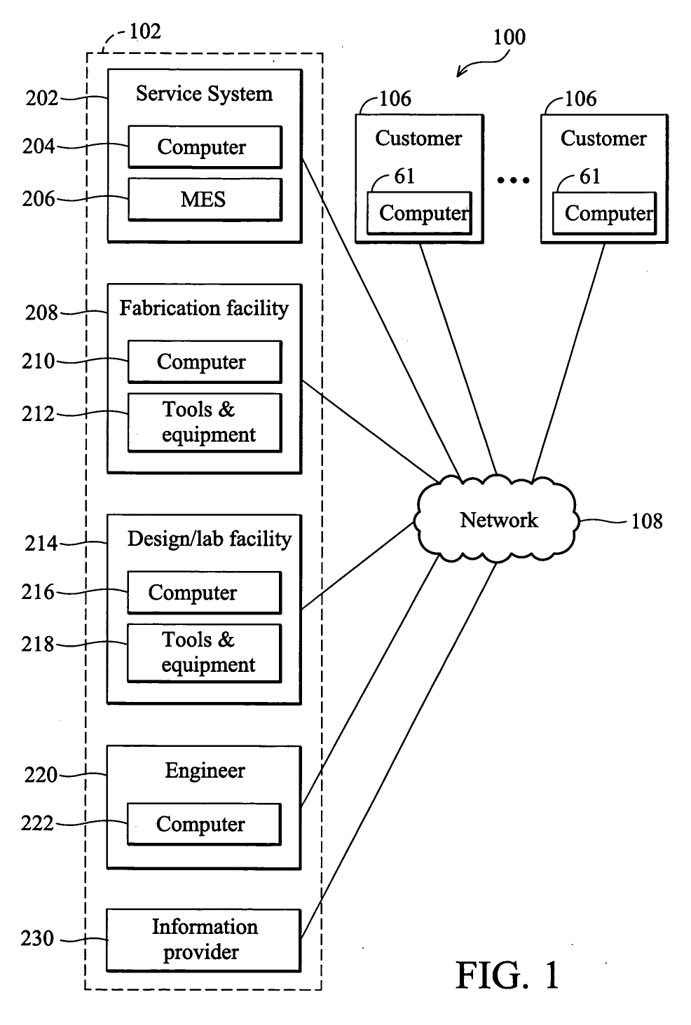

In FIG. 1, semiconductor foundry 102 comprises a plurality of entities, each of which includes a computer coupled to others and customers (such as customer 106) through network 108. Network 108 may be the Internet or an intranet implementing network protocols, such as transmission control protocol (TCP). Customer 106 may be an IC design company or other entity for IC processing. Each computer included in the entities comprises a network interface.

Service system 202 is an interface between a customer (such as customer 106) and semiconductor foundry 102 transferring information about semiconductor manufacturing. Service system 202 includes computer 204 facilitating such communication and a manufacturing execution system (MES) 206.

MES 206, coupled to other systems and entities of semiconductor foundry 102, performs various operations to facilitate IC manufacture. For example, MES 206 can receive various real-time information, organize and store the information in a centralized database, manage work orders, workstations, manufacturing processes and relevant documents, and track inventory.

Information provider 230 may be a computer or a system integrated into service system 202 to provide engineer data of IC manufacture to customers.

Fabrication facility 208 fabricates ICs. Accordingly, fabrication facility 208 includes fabrication tools and equipment 212. For example, tools and equipment 212 may comprise an ion implantation tool, a chemical vapor deposition tool, a thermal oxidation tool, a sputtering tool, various optical imaging systems, and software controlling the various tools and equipment. Fabrication facility 208 also includes computer 210.

Design/lab facility 214 conducts IC design and testing. Design/lab facility 214 may comprise design/test tools and equipment 218. The tools and equipment 218 comprise one or more software applications and hardware systems. Design/lab facility 214 also comprises computer 216.

Engineer 220 collaborates on IC manufacturing with other entities, such as service system 202 and other engineers. For example, engineer 220 can collaborate with other engineers and the design/lab facility 214 on design and testing of IC's, monitor fabrication processes at the fabrication facility 208, and receive information regarding runs and yield. Engineer 220 also communicates directly with customers, using computer 222 to perform various operations.

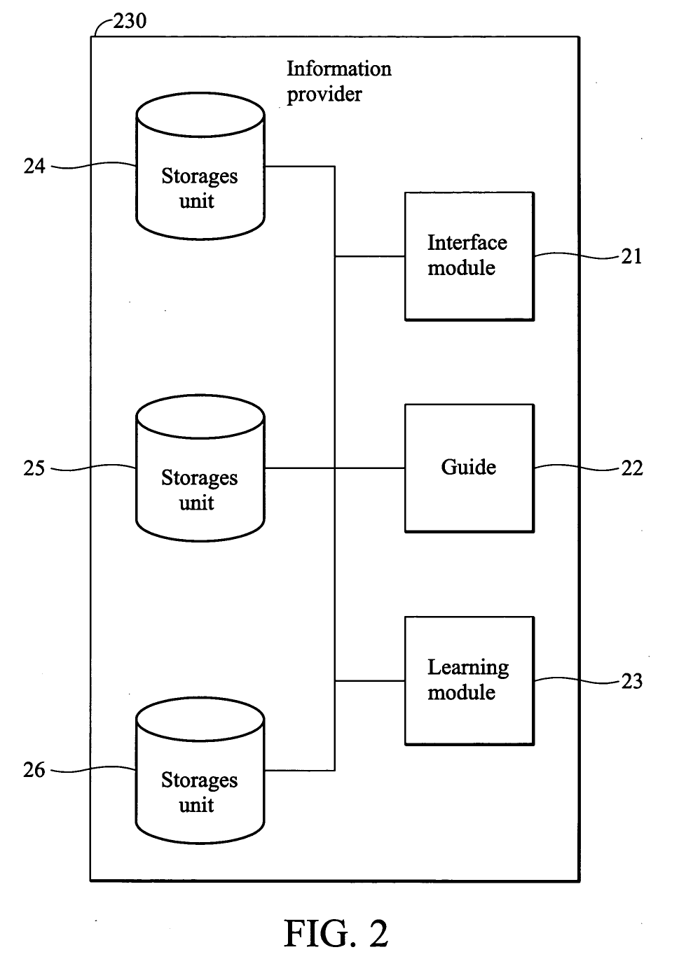

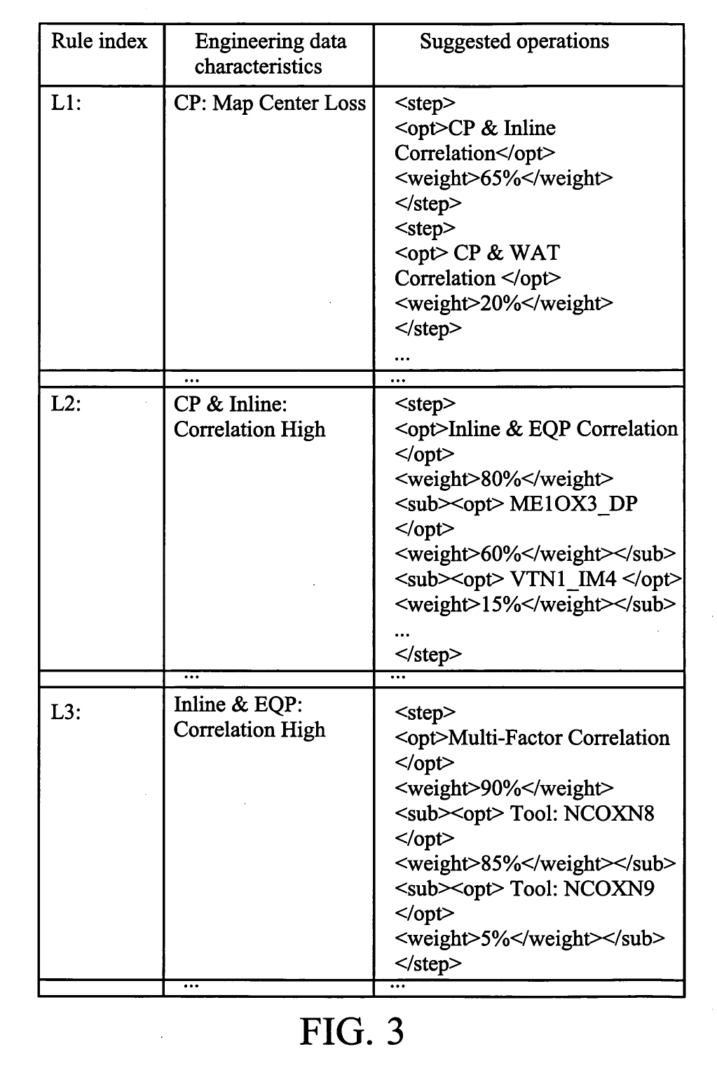

In information provider 230 of FIG. 2, first storage unit 24 stores engineering data of semiconductor manufacturing collected from environment 102. The engineering data sets comprise various information related to processes, stages, facilities, equipments, tools and others involved in IC manufacture and testing. Each entity in environment 102 may contribute engineering data to first storage unit 24 through a network (such as network 108). Second storage unit 25 stores rules, each associating characteristics of a portion of the engineering data set with at least one operation operable on interface module 21 of information provider 230. In FIG. 3, for example, each type of engineering data characteristics is associated with suggested information provider operations enclosed by tags <opt> and <opt>. Each suggested operation comprises a weight enclosed by tags <weight> and </weight>, representing the level to which an operation correlates to engineering data characteristics. Rules in second storage unit 25 may be predetermined or dynamically established by learning module 23, as described later.

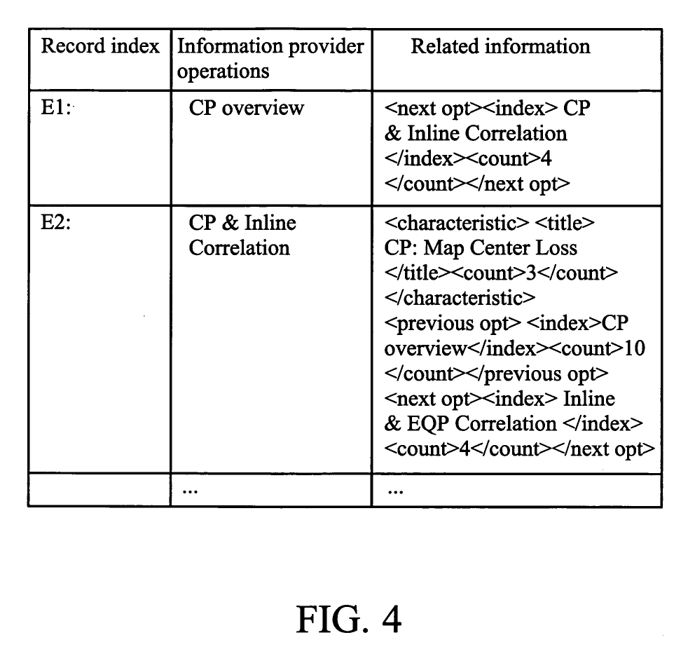

Third storage unit 26 stores historical operations implemented on interface module 21, each of which may be associated with another operation or characteristics of a portion of the engineering data set. In FIG. 4, the operation “CP & Inline Correlation” (E2), for example, correlates to “CP: Map Center Loss” marked by tags <characteristics>, and “CP overview” and “Inline & EQP Correlation” respectively marked by tags <previous opt> and <next opt>. The number therein marked by tags <count> and <count> indicates the times for which learning module 23 establishes or increases their correlations.

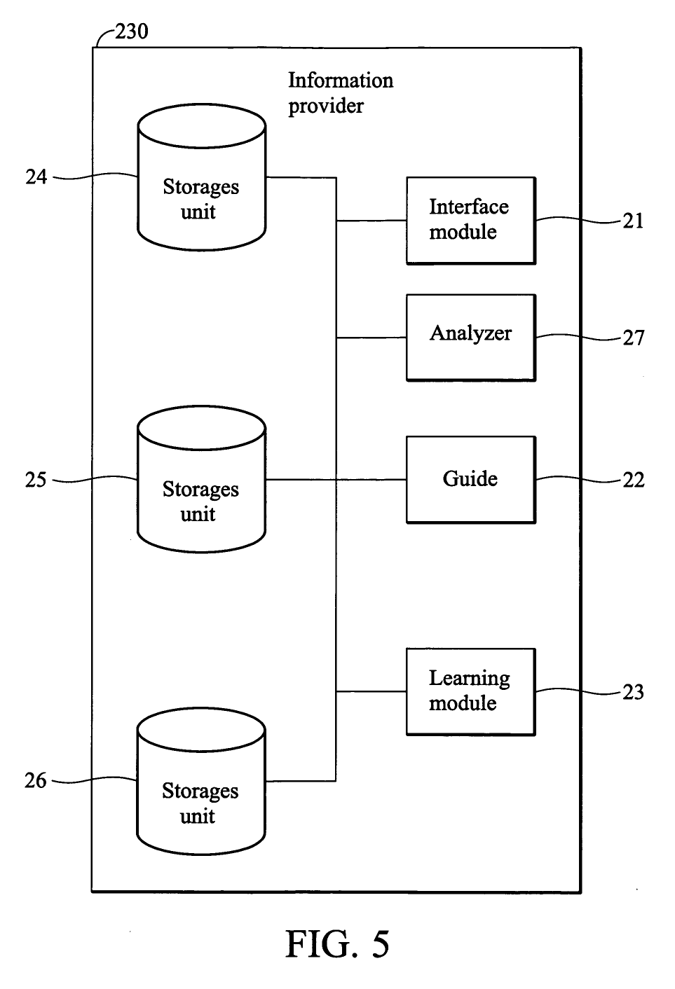

Interface module 21 serves as an interface receiving operations from customers (such as computer 61 of customer 106), accordingly locating a portion of the engineering data set from first storage unit 24 and in response providing the located data to customers. Guide 22 provides customers with direction to next operations corresponding to characteristics of the portion of the engineering data set. These characteristics may be automatically determined by an analyzer 27 (as shown in FIG. 5) or manually by customers and classified systematically into typical categories. For example, characteristics of the engineering data set (such as inline, Wafer Acceptance Test (WAT), and Circuit Probing (CP) data sets) and correlations therebetween can be determined and classified into a plurality of predetermined attributes, such as “Trend Up”, “Trend Down”, “Field Relative Loss”, “Map Center Loss”, “Out of Spec (OOS)/Out of Control (OOC)”, “Correlation High”, “Correlation Low”, “Map Left Down Loss”, and others. The information provided by interface module 21 and guide 22 may be automatically organized to form a webpage in Hypertext Markup Language (HTML) format or others wherein the provided direction may comprise hyperlinks or other user interface which, when selected, triggers another operation of interface module 21.

Learning module 23 enables information provider 230 to learn (adjust) correlation between engineering data characteristics and related operations operable on interface module 21. Note that interface module 21, guide 22, learning module 23, and storage units 24-26 may be centralized in an entity (such as a server) or distributed in multiple entities.

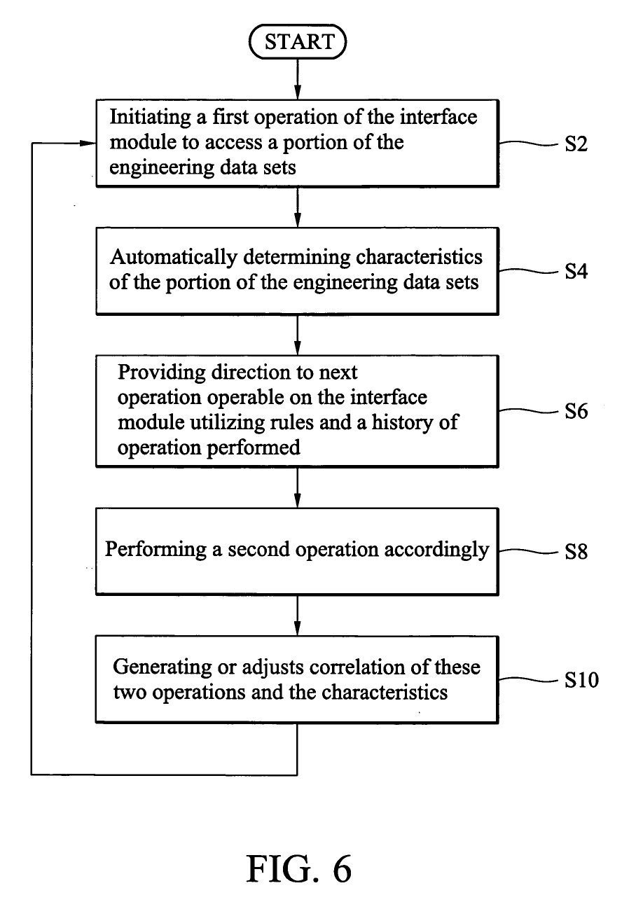

Information provider 230 may be a computer or a computer program automatically implementing the following steps. For clarity, only customer 106 is illustrated, cooperating with information provider 230. With reference to FIG. 6, customer 106 initiates a first operation of interface module 21 to access a portion of the engineering data sets stored in storage unit 24 through network 108 (step S2). When receiving the first operation, interface module 21 provides a portion of the engineering data sets in response through network 108. For example, when receiving a CP overview operation, interface module 21 locates and transmits a CP BIN8 map to computer 61 to be displayed. Analyzer 27 determines characteristics of the portion of the engineering data sets (such the CP BIN8 map) automatically or semi-automatically on demand from customer 106 (step S4). Note that the characteristic determination may take place before the first operation.

According to the determined characteristics, guide 22 generates direction to next operation on interface module 21 utilizing rules in second storage unit 25 and an operating history in third storage unit 26 (step S6). For example, when the CP BIN8 map is determined to be “Map Center Loss”, guide 22 searches storage units 25 and 26 with a keyword “CP: Map Center Loss” and locates rule L1 in FIG. 3 and record E2 in FIG. 4. Guide 22 provides direction to computer 61. FIG. 6 shows an example of the direction, wherein 70% and 20% are respective weights of suggested operations “CP & Inline Correlation” and “CP & WAT Correlation”, which may be derived from corresponding data (such as 65% and 20% between <weight> and </weight> in FIG. 3, and “3” between <count> and </count> in FIG. 4) within rule L1 and record E2. The direction may be displayed by a web browser on computer 61. Suggested operations therein may be undertaken or not.

Additionally, when no characteristic is determined, guide 22 may provide suggested operations corresponding to the first operation utilizing third storage unit 26. For example, guide 22 may locate record E1 and provide information comprising “CP & Inline Correlation”.

When receiving a second operation from computer 61, interface module 21 performs the second operation accordingly (step S8). For example, interface module 21 locates and provides a second portion of engineering data sets through networks. Alternatively, interface module 21 calculates correlations between engineering data sets. Learning module 23 accordingly establishes or adjusts correlation of these two operations and the characteristics (step S10). For example, learning module 23 can then record the second operation, the characteristics, and the first operation in third storage unit 26, thus associating these two operations and the characteristics.

If a first record in third storage unit 26 comprising these two operations and the characteristics already exists, learning module 23 adjusts information corresponding thereto to enhance correlation therebetween. For example, when “CP & Inline Correlation” is performed as the second operation, learning module 23 increases counts in records E1 and E2 accordingly.

If a rule exists in second storage unit 25 comprising the second operation and the characteristics, and the second operation is included in direction provided by guide 22, learning module 23 adjusts related information therein to enhance correlation between the second operation and the characteristics. For example, when “CP & Inline Correlation” is performed as the second operation, learning module 23 increases weight “65%” in rule L1 accordingly. If no rule exists in second storage unit 25 comprising the second operation and the characteristics, learning module 23 may generate a corresponding rule in second storage unit 25. For example, learning module 23 may not generate a corresponding rule in second storage unit 25 corresponding to the second operation and the characteristics until the count of the first record in third storage unit 26 exceeds a threshold value (such as zero or a greater value). Conditions according to which learning module 23 generates a corresponding rule in second storage unit 25 may be vary.

If a rule exists in second storage unit 25 comprising the second operation and the characteristics, while the second operation is not included in direction provided by guide 22, learning module 23 may not adjusts the rule.

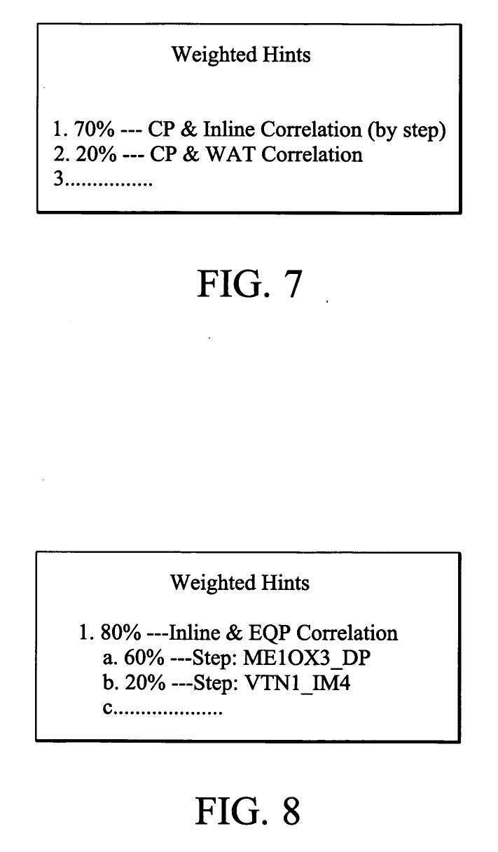

Similarly, when the CP & Inline Correlation is determined to be “Correlation High”, guide 22 searches storage units 25 and 26 with keywords “CP & Inline: Correlation High” and locates rule L2 in FIG. 3 and records (not shown) in third storage unit 26. FIG. 7 shows an example of the direction, wherein 80%, 60% and 20% are respective weights of suggested operations “Inline & EQP Correlation”, “ME1OX3₁₃DP”, and “VTN1_IM4”. These operations share a hierarchical relationship in which “ME1OX3_DP” and “VTN1_IM4” are sub-steps of “Inline & EQP Correlation”. The level of the hierarchical relationship may be greater.

Thus, hints for use of IC engineering data sets can be automatically generated, adjusted and provided to customers. The learning module provides self-learning mechanism to adjust the hints.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A data location method, implemented by an information provider comprising a first storage unit storing engineering data sets of a fabrication environment, wherein the information provider is coupled to a network, comprising:
receiving a first operation through the network from a computer apart from the fabrication environment;
providing a portion of the engineering data sets stored in the first storage unit to the computer through the network in response to the first operation; and
according to characteristics of the portion of the engineering data sets, automatically providing the computer with direction to a next operation operable on the information provider for locating or processing another portion of the engineering data sets.

2. The method as claimed in claim 1, wherein the provided direction points to a plurality of operations operable on the information provider, each associated with a weight.

3. The method as claimed in claim 2, wherein the operations share a hierarchical relationship where one of the operations is a sub-step of another operation thereof.

4. The method as claimed in claim 1, wherein the direction is provided based on a predetermined rule comprising correlation between the characteristics of the portion of engineering data sets and the next operation.

5. The method as claimed in claim 4, further comprising, when the next operation is performed, modifying the predetermined rule accordingly to enhance the correlation between the next operation and the characteristics of the portion of engineering data sets.

6. The method as claimed in claim 4, wherein the direction is provided based on a history of operations performed, of which at least one is associated with the characteristics of the portion of engineering data sets.

7. The method as claimed in claim 6, further comprising, when the next operation is performed, modifying the history accordingly to enhance correlation between the next operation and the characteristics of the portion of engineering data sets.

8. The method as claimed in claim 1, wherein the direction is provided based on a history of operations performed in which at least one performed operation is associated with the characteristics of the portion of engineering data sets.

9. The method as claimed in claim 1, further comprising automatic determination of the characteristics of the portion of engineering data sets.

10. The method as claimed in claim 1, wherein the engineering data sets of semiconductor manufacturing relate to semiconductor testing.

11. The method as claimed in claim 1, further comprising, when the next operation is performed, showing another portion of the engineering data sets.

12. A data location system, comprising:
a first storage unit coupled to a network, storing engineering data sets of a semiconductor fabrication environment;
an interface module coupled to the first storage unit, receiving a first operation from a computer apart from the fabrication environment and providing a portion of the engineering data sets to the computer through the network in response thereto; and
a guide coupled to the first storage unit and the interface module, according to characteristics of the portion of the engineering data sets, automatically providing the computer with direction to a next operation operable on the interface module for locating or processing another portion of the engineering data sets.

13. The system as claimed in claim 12, wherein the provided direction points to a plurality of operations operable on the interface module, each associated with a weight.

14. The system as claimed in claim 13, wherein the operable operations share a hierarchical relationship wherein each operation is a sub-step of another operation thereof.

15. The system as claimed in claim 12, further comprising a second storage unit coupled to the guide, storing predetermined rules, wherein the guide provides the direction based on a predetermined rule thereof associating the characteristics of the portion of engineering data sets with the next operation.

16. The system as claimed in claim 15, further comprising a learning module coupled to the guide, wherein when the next operation is performed, the predetermined rule is modified accordingly to enhance the correlation between the next operation and the characteristics of the portion of engineering data sets.

17. The system as claimed in claim 15, further comprising a third storage unit coupled to the guide, storing a history of operations performed, at least one of which is associated with the characteristics of the portion of engineering data sets, wherein the guide provides the direction based on the history.

18. The system as claimed in claim 17, further comprising a learning module coupled to the guide, wherein when the next operation is performed, the history is modified accordingly to enhance correlation between the next operation and the characteristics of the portion of engineering data sets.

19. The system as claimed in claim 12, further comprising a third storage unit coupled to the guide, storing a history of operations performed, at least one of which is associated with the characteristics of the portion of engineering data sets, wherein the guide provides the direction based on the history.

20. The system as claimed in claim 12, further comprising an analyzer coupled to the interface module, automatically determining the characteristics of the portion of engineering data sets.

21. The system as claimed in claim 12, wherein, when the next operation is performed, the guide shows another portion of the engineering data sets.

22. A data location system, comprising:
a first storage unit coupled to a network, storing the engineering data sets of a semiconductor fabrication environment performed by a semiconductor manufacturing entity;
an interface module coupled to the first storage unit, receiving a first operation from a computer apart from the fabrication environment, providing a portion of the engineering data sets to the computer through the network in response to the first operation, and subsequently receiving a second operation from the computer for locating or processing another portion of the engineering data sets through the network;
a third storage unit coupled to the interface module, storing a history of operations performed on the interface module; and
a learning module coupled to the interface module and the third storage unit, storing the second operation in the third storage unit, and associating the second operation with the characteristics of the portion of the engineering data sets thus to make the second operation as an option for the computer to respond to a further occasion characterized by the same characteristics of the portion of the engineering data sets.

23. The system as claimed in claim 22, further comprising a guide, coupled to the interface module and the third storage unit, wherein when the characteristics are determined, the guide automatically provides the computer with direction to the second operation based on the correlation between the second operation and the characteristics of the portion of the engineering data sets.

24. The system as claimed in claim 23, wherein, when the second operation is performed again, the learning module modifies the history accordingly to enhance correlation between the second operation and the characteristics of the portion of engineering data sets.

25. The system as claimed in claim 24, wherein, when the correlation has been enhanced to a predetermined level, the learning module generates a rule corresponding to the correlation for future direction by the guide direction to the second operation.

26. The system as claimed in claim 22, further comprising an analyzer coupled to the first storage unit and the interface module, automatically determining the characteristics of the portion of engineering data sets.

27. The system as claimed in claim 22, wherein, when the next operation is performed, the guide shows another portion of the engineering data sets.
